(19) United States
(12) Patent Application Publication
(10) Pub. No.: US 2025/0372065 A1
(43) Pub. Date: Dec. 4, 2025

(54) KARAOKE DEVICE AND VOICE SCORING SYSTEM THEREOF

(71) Applicant: REALTEK SEMICONDUCTOR CORP., Hsinchu (TW)

(72) Inventors: Yen-Hsun Chu, Hsinchu (TW); Yu-Che Kao, Hsinchu (TW)

(73) Assignee: REALTEK SEMICONDUCTOR CORP., Hsinchu (TW)

(21) Appl. No.: 19/213,380

(22) Filed: May 20, 2025

(30) Foreign Application Priority Data
May 31, 2024 (TW) 113120375

(51) Int. Cl. G10H 1/00; G09B 15/00; G10H 1/36; G10L 21/0308; G10L 25/18; G10L 25/30

(52) U.S. Cl. CPC G10H 1/0008; G09B 15/00; G10H 1/0066; G10H 1/361; G10L 21/0308; G10L 25/18; G10L 25/30; G10H 2210/005; G10H 2210/066; G10H 2220/005; G10H 2240/311; G10H 2250/311

(57) ABSTRACT

A voice scoring system is configured to be computed through a processing unit to execute: transforming an audiovisual audio of an audiovisual data and a user audio into a spectral intensity of the audiovisual data and a spectral intensity of the user audio respectively through a transformation module; separating the spectral intensity of the audiovisual audio into a spectral intensity of an accompaniment audio and a spectral intensity of a singer audio through an audio separation module; analyzing the spectral intensity of the singer audio and the spectral intensity of the user audio to obtain a singer pitch and a user pitch through a pitch analysis module; and in real time comparing whether the user pitch is close to the singer pitch to calculate a user score through the score calculation module. A karaoke device having the voice scoring system is also provided.

### CROSS-REFERENCE TO RELATED APPLICATION

This non-provisional application claims priority under 35 U.S.C. § 119 (a) to patent application No. 113120375 filed in Taiwan, R.O.C. on May 31, 2024, the entire contents of which are hereby incorporated by reference.

### BACKGROUND

### Technical Field

The present disclosure relates to an audiovisual entertainment device, and in particular, to a karaoke device and a voice scoring system thereof.

### Related Art

Generally, the evaluation of voice involves singing techniques such as pitch, vibrato, falsetto, or improvisation, and among these factors, pitch is played as the most critical reference factor. Many karaoke apps (applications) with scoring functions are available in smart device app stores, and most of which also use pitch as a criterion for evaluating the user's singing voice. These karaoke apps provide accompaniment music without vocals, allowing users to sing karaoke or practice singing along with the chosen accompaniment music. The accompaniment music includes pre-recorded vocal information synchronized with a timeline, which includes the pitch of the singer's voice. Using this pre-recorded singing information as a reference, the karaoke apps can score the user's voice. For example, when a user sings, a karaoke app can record the user's voice through a microphone, analyze the pitch of the user's voice, and compare the pitch of the user's singing voice with the pre-stored vocal information in the accompaniment music. The karaoke apps can compute the user score based on scoring algorithms of the karaoke apps.

In addition, some smart TVs on the market (such as Android TVs) are equipped with various audiovisual entertainment features, including karaoke. These smart TVs can play music videos through apps, and the karaoke system built in the TVs can remove or filter out the singer's voice from the music videos, allowing the speakers to output only the accompaniment music. Therefore, the users can sing karaoke along with the accompaniment music while watching music videos. However, the music videos played by the TV's built-in karaoke system do not contain pre-recorded vocal information like the accompaniment music provided by the karaoke apps. As a result, the TV system cannot score the user's singing voice.

### SUMMARY

One or some embodiments of the present disclosure provide a karaoke device comprising a network unit, a storage unit, an audio input unit, a processing unit, a display unit, and an audio output unit. The processing unit is electrically connected to the network unit, the storage unit, the audio input unit, the display unit, and the audio output unit. The processing unit receives an audiovisual data from the network unit or from the storage unit. The audiovisual data includes an audiovisual video (the video content within the audiovisual data) and an audiovisual audio (the audio content within the audiovisual data). A spectral intensity of the audiovisual audio can be obtained through a Fourier transform operation. By further processing the spectral intensity of the audiovisual audio, a spectral intensity of an accompaniment audio and a spectral intensity of a singer audio can be separated. Additionally, the processing unit receives a user audio from the audio input unit, and a spectral intensity of the user audio can be obtained through a Fourier transform operation. The accompaniment audio can be obtained by performing an inverse Fourier transform operation on the spectral intensity of the accompaniment audio. The accompaniment audio and user audio can be decoded by the processing unit and outputted through the audio output unit. The audiovisual video in the audiovisual data can be decoded by the processing unit and displayed through the display unit. The processing unit further processes the spectral intensity of the singer audio and the spectral intensity of the user audio, so that a singer pitch and a user pitch can be obtained. Then the user pitch is compared with the singer pitch in real-time to determine whether the user pitch is close to the singer pitch to calculate the user score.

One or some embodiments of the present disclosure provides a voice scoring system configured to be computed through a processing unit, and the voice scoring system comprises a transformation module, an audio separation module, a pitch analysis module, and a score calculation module. The transformation module performs a Fourier transform operation on an audiovisual audio and a user audio to obtain a spectral intensity of the audiovisual audio and a spectral intensity of the user audio. The audio separation module further processes the spectral intensity of the audiovisual audio to separate a spectral intensity of an accompaniment audio and a spectral intensity of a singer audio. The pitch analysis module further processes the spectral intensity of the singer audio and the spectral intensity of the user audio to obtain the singer pitch and the user pitch, respectively. The score calculation module then in real-time compares the user pitch with the singer pitch to determine whether the user pitch is close to the singer pitch and calculate the user score.

### BRIEF DESCRIPTION OF THE DRAWINGS

The instant disclosure will become more fully understood from the detailed description given herein below for illustration only, and therefore not limitative of the instant disclosure, wherein:

FIG. 1 illustrates a system block diagram of the karaoke device according to an embodiment of the present disclosure;

FIG. 2 illustrates a schematic view of the audio processing flow of the voice scoring system according to an embodiment of the present disclosure;

FIG. 3 illustrates a schematic view of the audio processing flow of the audio separation module according to an embodiment of the present disclosure;

FIG. 4 illustrates a flowchart of the audio processing flow of the pitch analysis module according to an embodiment of the present disclosure;

FIG. 5 illustrates a schematic view of the pitch conversion module according to an embodiment of the present disclosure;

FIG. 6 illustrates a flowchart of the score calculation module according to an embodiment of the present disclosure; and

FIG. 7 illustrates a schematic view of the windows of the short-time Fourier transform according to an embodiment of the present disclosure.

### DETAILED DESCRIPTION

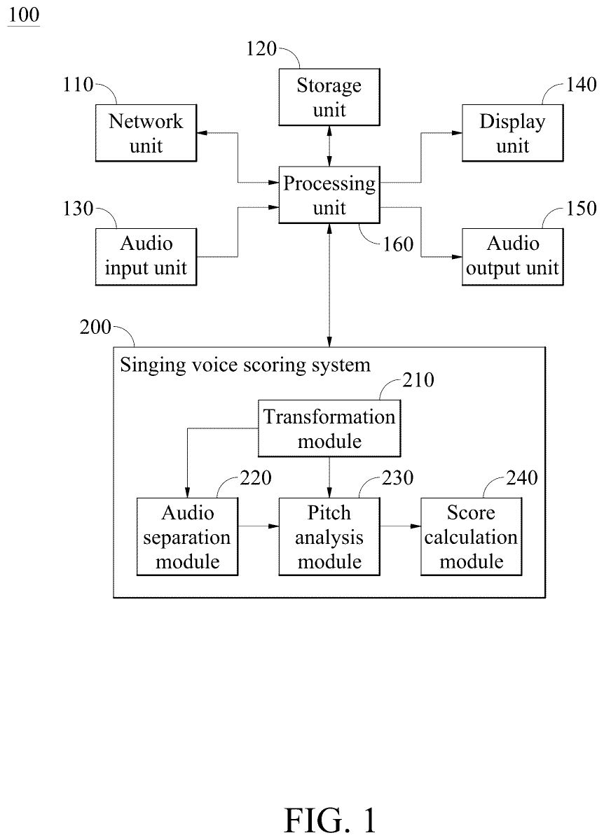

FIG. 1 illustrates a system block diagram of the karaoke device according to an embodiment of the present disclosure. Please refer to FIG. 1, the karaoke device 100 of an embodiment of the present disclosure comprises a network unit 110, a storage unit 120, an audio input unit 130, a display unit 140, an audio output unit 150, and a processing unit 160. The processing unit 160 is electrically connected to the network unit 110, the storage unit 120, the audio input unit 130, the display unit 140, and the audio output unit 150. The karaoke device 100 can be a karaoke machine, a multimedia device, a television with a built-in karaoke system, or a smart TV capable of executing a karaoke app (application). The network unit 110 receives audiovisual data from the Internet, which includes an audiovisual video (the video content within the audiovisual data) and an audiovisual audio (the audio content within the audiovisual data). In one embodiment, the source of the audiovisual data can be an audiovisual streaming platform, such as YouTube. The audiovisual data of the music videos from the audiovisual streaming platform are streamed to the karaoke device 100 in a streaming data format. The storage unit 120 stores audiovisual data for playback by the karaoke device 100. In one embodiment, the source of the audiovisual data can be the storage unit 120 of the karaoke device 100, which stores the music videos or accompaniment music. The audio input unit 130 receives and records the user's singing voice. In one embodiment, the audio input unit 130 comprises a microphone and an analog-to-digital converter (ADC), in which the microphone receives the user's voice and the analog-to-digital converter converts the user's singing voice into a digital recording audio. The digital recording audio of the user's singing voice is referred to as the “user audio” herein. The display unit 140 receives the audiovisual video from the audiovisual data and displays the audiovisual video through a monitor or screen. The audio output unit 150 receives the audiovisual audio and the user audio processed by the processing unit 160 and outputs the audiovisual audio and the user audio through speakers or headphones. According to one or some embodiments of the present disclosure, the karaoke device 100 in real-time processes the audiovisual data during playback to obtain the singer pitch from the audiovisual data. In one embodiment, the karaoke device 100 receives streaming data from an audiovisual streaming platform and in real-time processes the streaming data during playback to obtain the singer pitch at the same time.

The processing unit 160 is used to process the audiovisual data and the user audio. The processing unit 160 includes a processor capable of performing computations and processing audio/video encoding/decoding, such as a Central Processing Unit (CPU), a Graphics Processing Unit (GPU), an Audio/Voice Digital Signal Processor, or other similar components or a combination of the aforementioned components. In one embodiment, the processing unit 160 can be a multimedia chip or a television chip.

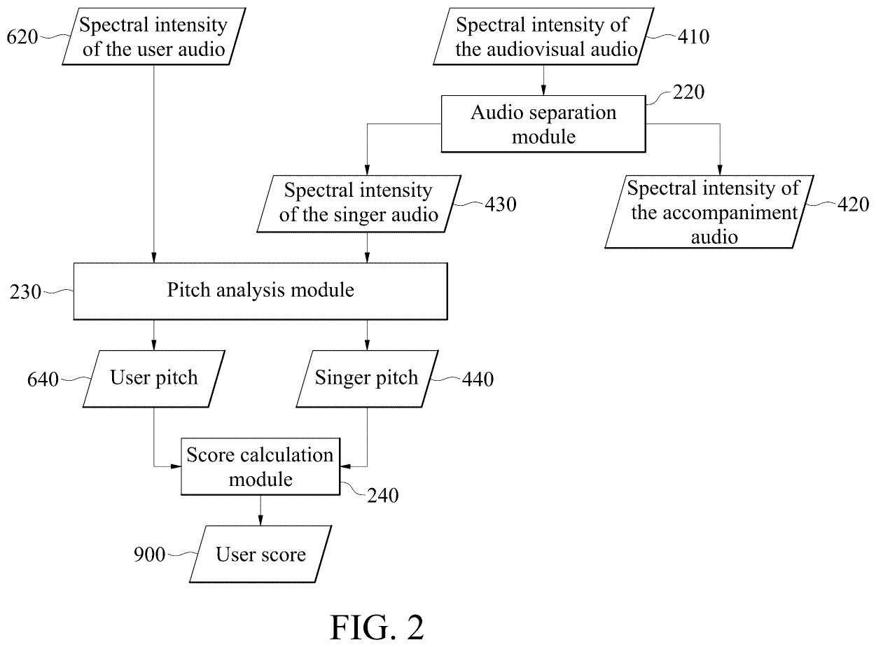

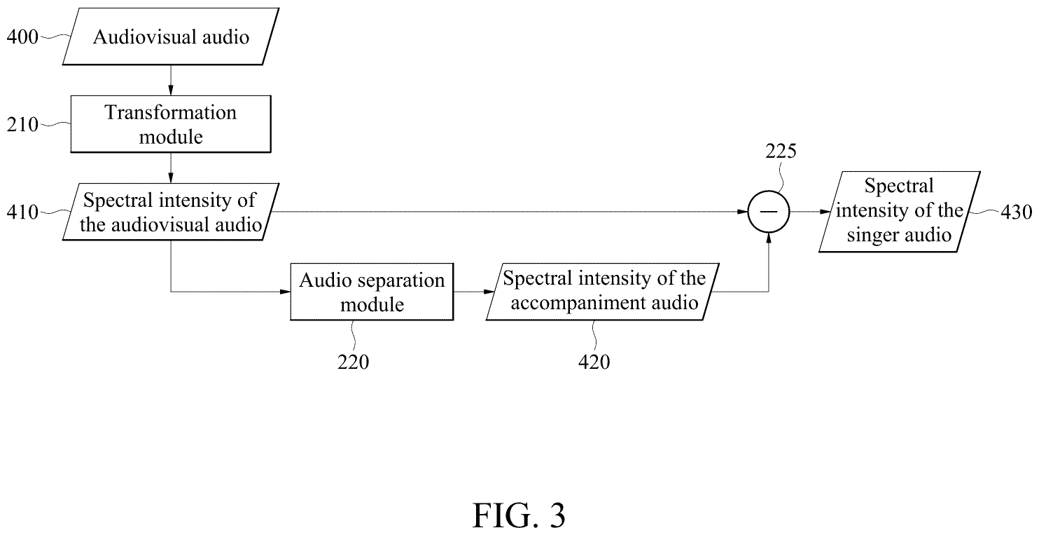

FIG. 2 illustrates a schematic view of the audio processing flow of the voice scoring system according to an embodiment of the present disclosure, and FIG. 3 illustrates a schematic view of the audio processing flow of the audio separation module according to an embodiment of the present disclosure. Please refer to FIG. 1 to FIG. 3, the processing unit 160 first performs a Fourier transform operation on the audiovisual audio 400 through the transformation module 210, such as a fast Fourier transform (FFT) or short-time Fourier transform (STFT). In one embodiment, taking the STFT operation as an example, the parameters of the STFS include: an audio sampling rate of 48 kHz, a window length of 4096 samples, and a hop length of 1024 samples. After conversion, the window length corresponds to approximately 85.33 milliseconds (4096/48000 seconds), and the hop length corresponds to approximately 21.33 milliseconds (1024/48000 seconds). The choice of the window length affects the frequency resolution and the time resolution. By setting the parameters as described above, it is ensured that the audio can be processed faster, with low latency, while the clarity of voice can be maintained. Although the window length is set as 4096 samples in this embodiment, the present disclosure is not limited to thereto; in some embodiments, the window length may also be a multiple of 512 samples, such as 512, 1024, or 2048 samples. Likewise, although the window length is 4 times the hop length in this embodiment, the present disclosure is not limited to thereto; in some embodiments, the window length may be a multiple of the hop length, such as 8 times or 16 times, and so on. After the STFT operation, the audio is transformed from the time domain to the frequency domain, resulting in a complex spectrum that includes the spectral intensity and spectral phase of each frequency component. The spectral intensity represents the intensity or magnitude of the audio at each frequency component, illustrating the relationship between amplitude and frequency on a spectrum, where the horizontal axis represents frequency and the vertical axis represents amplitude. The spectral phase represents the relative time shift of the audio at each frequency component, illustrating the relationship between phase and frequency on a spectrum, where the horizontal axis represents frequency and the vertical axis represents phase. The spectral intensity is obtained by taking the square root of the sum of the squares of the real part and the imaginary part after performing the STFT operation, with the formula as follows:

$$M ( ω ) = \sqrt{{( Re \{ W ( j ω ) \} )}^{2} + {( I m \{ W ( j ω ) \} )}^{2}}$$

Where M(ω) represents the spectral intensity at frequency ω in the frequency domain; W(jω) represents the spectral signal after the STFT operation; Re {W(jω)} represents the real part after the STFT operation, indicating the real component of the frequency in the frequency domain; and Im {W(jω)} represents the imaginary part after the STFT operation, indicating the imaginary component of the frequency in the frequency domain. Therefore, in one embodiment, the spectral intensity of the audiovisual audio 410 can be obtained by performing the STFT operation on the audiovisual audio 400. Likewise, in one embodiment, the spectral intensity of the user audio 620 can be obtained by performing the STFT operation on the user audio.

After the processing unit 160 obtains the spectral intensity of the audiovisual audio 410, the processing unit 160 analyzes the spectral intensity of the audiovisual audio 410 to separate a spectral intensity of a singer audio 430 and a spectral intensity of an accompaniment audio 420 through the audio separation module 220. In one embodiment, the audio separation module 220 analyzes the spectral intensity of the audiovisual audio 410 to obtain the spectral intensity of the accompaniment audio 420. By subtracting the spectral intensity of the accompaniment audio 420 from the spectral intensity of the audiovisual audio 410 using a spectral subtraction operation 225, the spectral intensity of the singer audio 430 can be obtained. The spectral subtraction operation 225 is executed through the processing unit 160. Likewise, in one embodiment, the audio separation module 220 analyzes the spectral intensity of the audiovisual audio 410 to obtain the spectral intensity of the singer audio 430. By subtracting the spectral intensity of the singer audio 430 from the spectral intensity of the audiovisual audio 410 using the spectral subtraction operation 225, the spectral intensity of the accompaniment audio 420 can be obtained. Likewise, in one embodiment, the audio separation module 220 analyzes the spectral intensity of the audiovisual audio 410 to obtain the spectral intensity of the singer audio 430 and the spectral intensity of the accompaniment audio 420, respectively. In one embodiment, the audio separation module 220 further includes an artificial intelligence model capable of performing voice recognition, which is trained to recognize voices or specific voice/sound features from the spectral intensity of the audiovisual audio 410 using a recurrent neural network (RNN) or a long short-term memory model (LSTM). Accordingly, identification of elements of specific voices/sounds, such as vocal voice, instrument sound, or accompaniment sound. Although the aforementioned embodiment uses an artificial intelligence model trained with a neural network such as RNN or LSTM as an example, the present disclosure is not limited thereto. Any model capable of extracting specific sound/voice features from the spectral intensity of the audiovisual audio 410 to obtain singer's voice and accompaniment music separation is applicable.

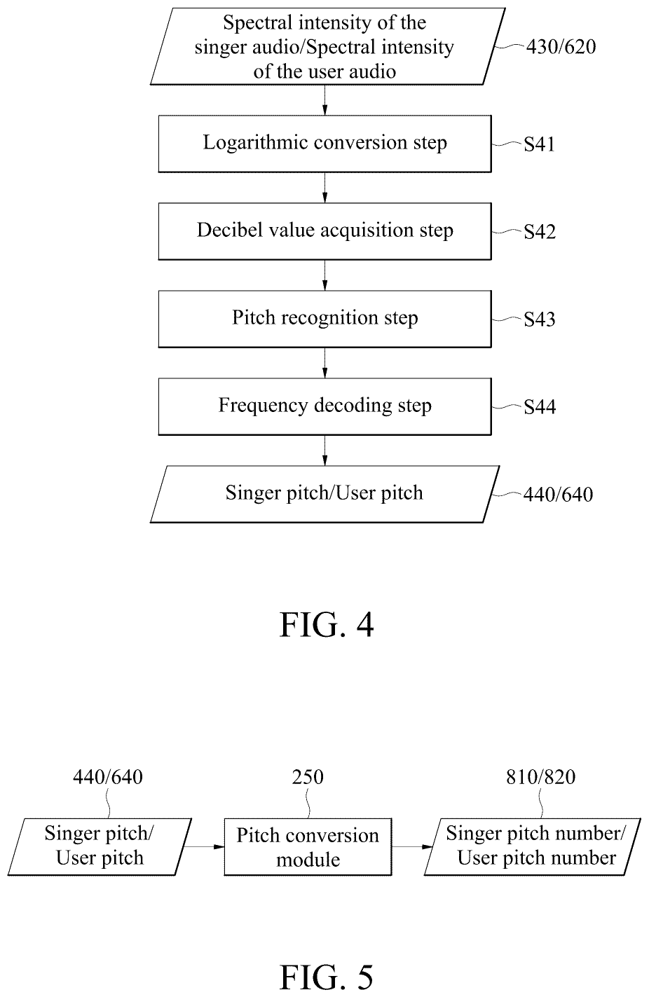

FIG. 4 illustrates a flowchart of the audio processing flow of the pitch analysis module according to an embodiment of the present disclosure. Please refer to FIG. 4, in frequency domain analysis, the frequency components of audio are typically understood by observing the spectral intensity of the audio, where the pitch refers to the highness or lowness of voice, correlated with frequency, and the human ears' perception of pitch typically follows a logarithmic scale. Please refer to FIG. 4, the pitch analysis module 230 of the present disclosure includes several processing steps in the process of analyzing the spectral intensity of the singer audio 430 and the spectral intensity of the user audio 620 to obtain the singer pitch 440 and the user pitch 640.

First, in the step S41, a logarithmic conversion step is executed, in which the processing unit 160 performs a logarithmic conversion on the spectral intensity of the singer audio 430 to convert the spectral intensity of the singer audio 430 into a logarithmic spectrum through a logarithmic conversion module. Likewise, the processing unit 160 performs the logarithmic conversion on the spectral intensity of the user audio 620 to convert the spectral intensity of the user audio 620 into the logarithmic spectrum through the logarithmic conversion module.

Next, in the step S42, a decibel value acquisition step is executed, in which the processing unit 160 extracts a decibel (dB) value from the spectral intensity in the logarithmic spectrum. Therefore, the observation of the harmonic structure of interest on a decibel scale can be achieved easily. In one embodiment, the amplitude of each spectral intensity in the logarithmic spectrum is extracted as the decibel value, for example, taking the absolute value of the amplitude as the decibel value.

Then, in the step S43, a pitch recognition step is executed, in which the processing unit 160 analyzes the decibel value to recognize pitch through an artificial intelligence model capable of performing pitch recognition, and an encoded value is output from the artificial intelligence model. The artificial intelligence model is trained using recurrent neural network (RNN) or long short-term memory model (LSTM). The artificial intelligence model is trained to discern various pitches or frequencies from the spectral intensity of the audio or the decibel values. In one embodiment, the artificial intelligence model includes 128 outputs encoded as integers ranging from 0 to 127, and each of the encoded values corresponds to a corresponding specific pitch or frequency. In other words, in this embodiment, the artificial intelligence model can discern 128 different pitches or frequencies. Although the aforementioned embodiment uses an artificial intelligence model that can discern 128 pitches or frequencies as an example, the present disclosure is not limited thereto; in some embodiments, the artificial intelligence model can also be trained to discern 64 or 256 pitches or frequencies, either.

Next, in the step S44, a frequency decoding step is executed, in which the processing unit 160 decodes the encoded value outputted by the artificial intelligence model capable of performing pitch recognition through a frequency decoding module, and the processing unit 160 converts the encoded value into a frequency value in Hertz (Hz). In other words, in this embodiment, the frequency decoding module can decode the encoded values outputted by the artificial intelligence model capable of performing pitch recognition into frequencies that have physical meaning.

In one embodiment, after the above steps are executed, the pitch analysis module 230 analyzes the spectral intensity of the singer audio 430 to obtain a frequency value corresponding to the spectral intensity of the singer audio, wherein the frequency value represents the singer pitch 440. Likewise, in one embodiment, after the above steps are executed, the pitch analysis module 230 analyzes the spectral intensity of the user audio 620 to obtain a frequency value corresponding to the spectral intensity of the user audio 620, wherein the frequency value represents the user pitch 640.

In one embodiment, the pitch analysis module 230 can also be implemented using a pitch detection algorithm, such as the YIN algorithm.

FIG. 5 illustrates a schematic view of the pitch conversion module according to an embodiment of the present disclosure. Please refer to FIG. 5, since the singer pitch 440 and the user pitch 640 obtained through the pitch analysis module 230 are frequency values, the processing unit 160 can specifically process the singer pitch 440 and the user pitch 640 in advance for the convenience of comparison by the score calculation module 240. The frequency values output by the pitch analysis module 230 are converted into Musical Instrument Digital Interface (MIDI) pitch note numbers through a pitch conversion module 250. The pitch conversion module 250, based on the standard of the MIDI, converts the frequency values output from the pitch analysis module 230 into corresponding MIDI note numbers. Specifically, in this embodiment, the score calculation module 240 comprises a pitch conversion module 250 which includes a conversion formula as follows:

$$f = 440 \cdot {2}^{( n - 69 ) / 12}$$

Where f represents a frequency value, and n represents a MIDI note number, which is an integer between 0 and 127. Therefore, in one embodiment, the pitch conversion module 250 converts the singer pitch 440 into a corresponding MIDI note number, resulting in a singer pitch number 810. In another embodiment, the pitch conversion module 250 converts the user pitch 640 into a corresponding MIDI note number, resulting in a user pitch number 820.

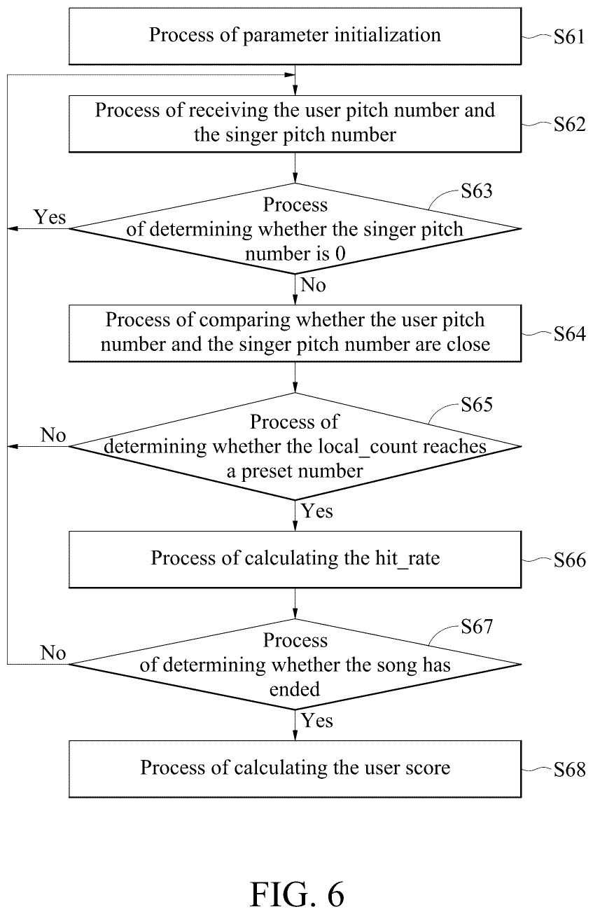

FIG. 6 illustrates a flowchart of the score calculation module according to an embodiment of the present disclosure. Please refer to FIG. 6, after the score calculation module 240 obtains the singer pitch number 810 and the user pitch number 820, the score calculation module 240 of one or some embodiments of the present disclosure compares in real-time whether the user pitch 640 is close to the singer pitch 440 to calculate the user score 900, which involves several processing steps (steps S61-S68).

First, in the step S61, a process of parameter initialization is executed, where the processing unit 160 initializes the parameters or variables such as local_hit, hit_sum, local_count, global_count, and these parameters or variables are all set as zero.

Next, in the step S62, a process of receiving the user pitch number 820 and the singer pitch number 810 is executed, where the processing unit 160 receives the user pitch number 820 and the singer pitch number 810 from the pitch conversion module 250 at regular time intervals. For example, the regular time interval may be 30 milliseconds, but the present disclosure is not limited thereto; in some embodiments, the regular time interval may also be 40 milliseconds, 50 milliseconds, or 60 milliseconds.

Then, in the step S63, a process of determining whether the singer pitch number 810 is 0 is executed, where the processing unit 160 determines whether the singer pitch number 810 is 0. When the singer pitch number 810 is 0, it represents that there is no singer's voice in the currently playing song, possibly only accompaniment music such as the intro, interlude, or outro of the song. Therefore, no action is to be executed; and the process simply returns to the previous step to keep receiving the user pitch number 820 and the singer pitch number 810. When the singer pitch number 810 is not 0, the next step is executed.

In the step S64, a process of comparing whether the user pitch number 820 and the singer pitch number 810 are close is executed, where the processing unit 160 compares whether a difference between the user pitch number 820 and the singer pitch number 810 is less than or equal to a tolerance value, such as 1 or 2. At this point, the local_count is incremented by 1. When the difference between the user pitch number 820 and the singer pitch number 810 is less than or equal to the tolerance value, it is determined to be close, representing a hit. At this point, the local_hit is incremented by 1. In one embodiment, when the user pitch number 820 and the singer pitch number 810 are the identical or just differ by one pitch number, the user pitch number 820 and the singer pitch number 810 can be considered close, but the present disclosure is not limited thereto. In another embodiment, when the user pitch number 820 and the singer pitch number 810 are the identical or just differ by two pitch numbers, the user pitch number 820 and the singer pitch number 810 may also be considered as close.

Next, in the step S65, a process of determining whether the local_count reaches a preset number is executed, where the processing unit 160 determines whether the local_count has reached a preset number, for example, 50, but not limited thereto. if the local_count has not reached the preset number, the process returns to the step S62 to receive the user pitch number 820 and the singer pitch number 810. If the local_count reaches the preset number, it indicates that the process of comparing whether the user pitch number 820 and the singer pitch number 810 are close in step S64 has been executed for the preset number of times, and then the next step is executed.

In the step S66, a process of calculating the hit_rate is executed, where the processing unit 160 calculates the hit_rate which is equal to the local_hit divided by the local_count. For example, after the process of comparing whether the user pitch number 820 and the singer pitch number 810 are close in step S64 has been executed for 50 times, at this point, assuming the local_count is 50 and the cumulative local_hit is 42, the hit_rate is this calculated to be 0.84 (42/50). At this point, the hit_sum will be updated, where the hit_sum is equal to the hit_sum plus the hit_rate. In other words, in some embodiments, the hit_sum is equivalent to summing up the hit_rate obtained each time. At this point, the local_hit and the local_count are set as zero, and the global_count is incremented by 1.

In the step S67, a process of determining whether the song has ended is executed, where the processing unit 160 determines whether the song has ended. For example, the processing unit 160 determines whether the song has stopped playing or determines whether the user has stopped singing based on the variation of the user pitch number 820 and the singer pitch number 810 over time. When the processing unit 160 determines that the song has not ended, the process returns to the step S62 to receive the user pitch number 820 and the singer pitch number 810. When the processing unit 160 determines that the song has ended, the next step is executed.

Finally, in the step S68, a process of calculating the user score 900 is executed, where the processing unit 160 calculates the user score 900 and determines whether to output the user score 900, wherein the user score 900 is equal to the hit_sum divided by the global_count, then multiplied by 10,000. In other words, in some embodiments, the user score 900 is calculated by averaging the hit_rate and scaling the hit_rate by 10,000, in which the user score 900 will range between 0 and 10000, but the present disclosure is not limited thereto; in one embodiment, the scaling factor may also be set as 10, 100, or 1000. In one embodiment, the score calculation module 240 can determine whether the user score 900 is accurate enough, for example, by determining whether the difference in the hit_rate obtained each time exceeds a certain proportion, so that the score calculation module 240 can determine whether to output the user score 900. In one embodiment, the score calculation module 240 can also determine whether to output the user score 900 according to whether the user singing time exceeds a threshold value, such as 3 seconds, so that the score calculation module 240 can determine whether to output the user score 900.

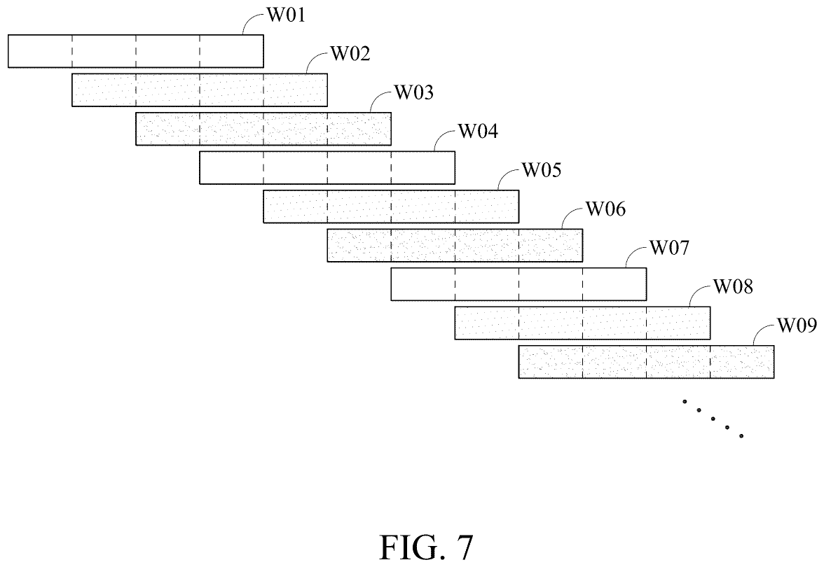

FIG. 7 illustrates a schematic view of the windows of the short-time Fourier transform according to an embodiment of the present disclosure. Please refer to FIG. 7, in one embodiment, the STFT parameters include an audio sampling rate of 48 kHz, a window length of 4096 samples, as illustrated by W01 to W09 in FIG. 7, and a hop length of 1024 samples, as illustrated by the displacement between two adjacent windows among W01 to W09 in FIG. 7. Therefore, after conversion, the window length corresponds to approximately 85.33 milliseconds (4096/48000), and the hop length corresponds to approximately 21.33 milliseconds (1024/48000). The audio separation module 220 separates the spectral intensity of the audiovisual audio 410 into the spectral intensity of the singer audio 430 and the spectral intensity of the accompaniment 420 in every window. The processing unit 160 performs an inverse Fourier transform operation on the spectral intensity of the accompaniment 420 to produce the accompaniment music, which is then output through audio output unit 150.

In one embodiment, the pitch analysis module 230 does not compute the singer pitch 440 in every window; instead, the pitch analysis module 230 only analyzes the spectral intensity of the singer audio 430 to obtain the singer pitch 440 every third window, for example in the 1^{st} window (W01), the 4^{th} window (W04), the 7^{th} window (W07), and so forth, corresponding to windows of the form 1+3 k (where k is a positive integer). Likewise, the pitch analysis module 230 does not compute the user pitch 640 in every window; instead, the pitch analysis module 230 only analyzes the spectral intensity of the user audio 620 to obtain the user pitch 640 every third window, for example, in the 2^{nd} window (W02), the 5^{th} window (W05), the 8^{th} window (W08), and so forth, corresponding to windows of the form 2+3 k (where k is a positive integer). Therefore, the pitch analysis module 230 does not need to compute pitch in the 3^{rd} window (W03), the 6^{th} window (W06), the 9^{th} window (W09), and so forth. The pitch analysis module 230 just synchronously updates the singer pitch 440 and the user pitch 640 obtained in the previous two windows to the score calculation module 240. In other words, in some embodiments, the pitch analysis module 230 does not need to update pitch to the score calculation module 240 in every window but just synchronously updates the singer pitch 440 and the user pitch 640 every third window, for example, in the 3^{rd} window (W03), the 6^{th} window (W06), the 9^{th} window (W09), and so forth, corresponding to windows of the form 3+3 k (where k is a positive integer). Accordingly, frequent data updating processes between the pitch analysis module 230 and the score calculation module 240 can be reduced, thereby saving system resources and improving system efficiency.

Next, it is explained that the synchronous updates of the user pitch 640 and the singer pitch 440 can be processed in real-time by the score calculation module 240. Taking the 1^{st} window (W01) to the 3^{rd} window (W03) as an example, there is approximately three-quarters overlap between the 1^{st} window (W01) and the 2^{nd} window (W02). Therefore, the singer pitch 440 obtained in the 1^{st} window (W01) and the user pitch 640 obtained in the 2^{nd} window (W02) can be considered as obtained simultaneously. Additionally, the pitch analysis module 230 synchronously updates the singer pitch 440 and the user pitch 640 to the score calculation module 240 every third window, for example, in the 3^{rd} window (W03) and the 6^{th} window (W06), with a time difference equivalent to three hop lengths, approximately 64 milliseconds. Therefore, as long as the time of comparing the user pitch 640 and the singer pitch 440 in the score calculation module 240 is less than and close to three hop lengths, it is ensured synchronous updates of the user pitch 640 and the singer pitch 440 by the pitch analysis module 230 can be processed in real-time by the score calculation module 240. In one embodiment, the score calculation module 240 of the present disclosure compares the user pitch 640 and the singer pitch 440 every 30 milliseconds.

The voice scoring system 200 further comprises a virtualized visual interface to graphically present information about the user pitch 640 and the singer pitch 440. In one embodiment, the information of the singer pitch 440 is displayed using a box interval representation, for example, the singer pitch 440 obtained in the 1^{st} window (W01), the 4^{th} window (W04), the 7^{th} window (W07), and so forth. After the singer pitch 440 is converted into a corresponding singer pitch number 810 by the pitch conversion module 250, the range of the interval is extended to one pitch number more than and less than the singer pitch number 810 as plotting information to plot the box interval, which is displayed on the screen in a specific color, such as gray. In another embodiment, the information of the user pitch 640 is displayed using a curve representation, for example, the user pitch 640 obtained in the 2^{nd} window (W02), the 5^{th} window (W05), the 8^{th} window (W08), and so forth. After the user pitch 640 is converted into a corresponding user pitch number 820 by the pitch conversion module 250, the user pitch number 820 is used as plotting information to plot the curve, which is displayed on the screen in a specific color, such as light green. Therefore, the user can visually observe in real-time whether the curve falls within the box interval using the virtualized visual interface. Therefore, the users can find that whether the user's singing voice is close to the original singer's voice. When the curve does not fall within the box interval, the user can make corresponding adjustments to the pitch of the singing voice to improve the singing experience.

The voice scoring system 200 further comprises a user interface for scoring feedback, and the user interface is for displaying a text comment or an icon corresponding to the user score 900 on the screen. In one embodiment, when the user score 900 falls between 8000 and 10000 points, the screen displays the text comment “Perfect” and the icon of a “Gold Medal”; when the user score 900 falls between 6000 and 7999 points, the screen displays the text comment “Great” and the icon of a “Silver Medal”; when the user score 900 falls between 4000 and 5999 points, the screen displays the text comment “Average” and the icon of a “Bronze Medal”; when the user score 900 falls between 2000 and 3999 points, the screen displays the text comment “Keep it up”, and optionally shows the icon of a “Iron Medal”; and when the user score 900 falls between 0 and 1999 points, the screen displays the text comment “Find a teacher”, and optionally shows the icon of a “Tin Medal”. In one embodiment, the user interface for scoring feedback includes multiple combinations of text comments or icons, which can be supplemented with historical records to present various text comments or icons to motivate users and interact with the voice scoring system 200.

Although the present disclosure has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A voice scoring system, configured to be computed through a processing unit, wherein the voice scoring system comprises:
a transformation module for receiving an audiovisual audio and a user audio to transform the audiovisual audio into a spectral intensity of the audiovisual audio and transform the user audio into a spectral intensity of the user audio, respectively;
an audio separation module for separating a spectral intensity of an accompaniment audio and a spectral intensity of a singer audio from the spectral intensity of the audiovisual audio;
a pitch analysis module for analyzing the spectral intensity of the singer audio and the spectral intensity of the user audio to obtain a singer pitch and a user pitch, respectively; and
a score calculation module for in real-time comparing whether the user pitch is close to the singer pitch to calculate a user score.

2. The voice scoring system according to claim 1, wherein the transformation module performs a fast Fourier transform (FFT) operation or a short-time Fourier transform (STFT) operation through the processing unit.

3. The voice scoring system according to claim 1, wherein the audio separation module comprises an artificial intelligence model capable of performing voice recognition, and the artificial intelligence model is trained to recognize voices using a recurrent neural network (RNN) or a long short-term memory model (LSTM).

4. The voice scoring system according to claim 1, wherein the pitch analysis module executes a logarithmic conversion step, in which the spectral intensity of the singer audio and the spectral intensity of the user audio are converted to generate a logarithmic spectrum through the processing unit.

5. The voice scoring system according to claim 4, wherein the pitch analysis module executes a decibel value acquisition step, in which a decibel value is extracted from the logarithmic spectrum through the processing unit.

6. The voice scoring system according to claim 5, wherein the pitch analysis module executes a pitch recognition step, in which the decibel value is analyzed through the processing unit using an artificial intelligence model capable of performing pitch recognition, and an encoded value is outputted from the artificial intelligence model.

7. The voice scoring system according to claim 6, wherein the pitch analysis module executes a frequency decoding step, in which the encoded value is decoded into a frequency value in Hertz (Hz) through the processing unit and a frequency decoding module.

8. The voice scoring system according to claim 1, wherein the score calculation module comprises a pitch conversion module for respectively converting the user pitch and the singer pitch into a user pitch number and a singer pitch number based on a standard of Musical Instrument Digital Interface (MIDI).

9. The voice scoring system according to claim 8, wherein the score calculation module compares a difference between the user pitch number and the singer pitch number through the processing unit to determine whether the difference is less than or equal to a tolerance value, and the score calculation module determines the user pitch number is close to the singer pitch number when the difference is less than or equal to the tolerance value, wherein the tolerance value is 1 or 2.

10. The voice scoring system according to claim 1, wherein the transformation module comprises a plurality of windows, and the audio separation module separates the spectral intensity of the accompaniment audio and the spectral intensity of the singer audio in each of the plurality of windows.

11. The voice scoring system according to claim 1, wherein the transformation module comprises a plurality of windows, and the pitch analysis module obtains the singer pitch in the (1+3 k)-th window, the user pitch in the (2+3 k)-th window, and synchronously updates the singer pitch and the user pitch to the score calculation module in the (3+3 k)-th window, wherein k is a positive integer.

12. The voice scoring system according to claim 1, further comprising a virtualized visual interface to graphically present information about the user pitch and the singer pitch.

13. The voice scoring system according to claim 1, further comprising a user interface for scoring feedback, and the user interface is for displaying a text comment or an icon corresponding to the user score.

14. A karaoke device comprising:
a network unit for receiving an audiovisual data from a network, wherein the audiovisual data comprises an audiovisual video and an audiovisual audio;
an audio input unit for receiving a user audio from a microphone; and
a processing unit electrically connected to the audio input unit and the network unit;
wherein the processing unit performs a Fourier transform operation on the audiovisual audio and the user audio to transform the audiovisual audio and the user audio into a spectral intensity of the audiovisual audio and a spectral intensity of the user audio, respectively; the processing unit separates a spectral intensity of an accompaniment audio and a spectral intensity of a singer audio from the spectral intensity of the audiovisual audio; the processing unit analyzes the spectral intensity of the singer audio and the spectral intensity of the user audio to obtain a singer pitch and a user pitch; and the processing unit in real-time compares whether the user pitch is close to the singer pitch to calculate a user score.

15. The karaoke device according to claim 14, wherein the audiovisual data is received from an audiovisual streaming platform, and the audiovisual data is processed during playback of the audiovisual data to obtain the singer pitch.

16. The karaoke device according to claim 14, further comprising:
a storage unit for storing the audiovisual data or providing the audiovisual data to the processing unit;
a display unit for displaying the audiovisual video; and
an audio output unit for outputting the user audio and an accompaniment audio, wherein the accompaniment audio is obtained by performing an inverse Fourier transform operation on the spectral intensity of the accompaniment audio;
wherein the processing unit is electrically connected to the storage unit, the display unit, and the audio output unit.

17. The karaoke device according to claim 14, further comprising:
a transformation module for obtaining the spectral intensity of the audiovisual audio and the spectral intensity of the user audio;
an audio separation module for obtaining the spectral intensity of the accompaniment audio and the spectral intensity of the singer audio;
a pitch analysis module for obtaining the singer pitch and the user pitch; and
a score calculation module for in real-time comparing whether the user pitch is close to the singer pitch to obtain the user score.

18. The karaoke device according to claim 17, wherein the audio separation module comprises an artificial intelligence model capable of performing voice recognition, and the artificial intelligence model is trained to recognize voices using a recurrent neural network (RNN) or a long short-term memory model (LSTM).

19. The karaoke device according to claim 17, wherein the pitch analysis module executes the following steps:
a logarithmic conversion step, in which a logarithmic spectrum is obtained from the spectral intensity of the singer audio or the spectral intensity of the user audio;
a decibel value acquisition step, in which a decibel value is extracted from the logarithmic spectrum;
a pitch recognition step, in which the decibel value is analyzed to obtain an encoded value through an artificial intelligence model capable of performing pitch recognition; and
a frequency decoding step, in which the encoded value is decoded into a frequency value in Hertz (Hz).

20. The karaoke device according to claim 17, wherein the score calculation module comprises a pitch conversion module for respectively converting the user pitch and the singer pitch into a user pitch number and a singer pitch number based on a standard of Musical Instrument Digital Interface (MIDI).
